(19) United States
(12) Patent Application Publication
(10) Pub. No.: US 2026/0316135 A1
(43) Pub. Date: Oct. 15, 2026

(54) BILLET ROTATING AND HOLDING DEVICE, AND BILLET HOLDING UNIT

(71) Applicant: TERAL INC., Fukuyama-shi, Hiroshima (JP)

(72) Inventors: Hiroshi KAWASHIMA, Fukuyama-shi, Hiroshima (JP); Tetsuya ITO, Fukuyama-shi, Hiroshima (JP); Takayuki SHO, Fukuyama-shi, Hiroshima (JP)

(73) Assignee: TERAL INC., Fukuyama-shi, Hiroshima (JP)

(21) Appl. No.: 19/483,655

(22) PCT Filed: Feb. 14, 2025
(86) PCT No.: PCT/JP2025/005055

§ 371 Date: Nov. 12, 2025

(30) Foreign Application Priority Data
Mar. 26, 2024 (JP) 2024-050094

(51) Int. Cl. B21C 33/00

(52) U.S. Cl. CPC B21C 33/00

(57) ABSTRACT

A billet rotating and holding device S includes an electric motor M, a pressurizer P, and a billet holding unit U. The billet holding unit includes an electric motor-side holder and a pressurizer-side holder. The billet holding unit is configured to clamp the end faces of the billet on both axial direction sides with the electric motor-side holder and the pressurizer-side holder using a pressing force towards an axial direction first side outputted from a pressurizer shaft. The electric motor-side holder and the pressurizer-side holder include a fixing portion, a floating portion, and a main body elastic portion.

### TECHNICAL FIELD

The present application claims priority to Japanese Patent Application No. 2024-050094 filed on Mar. 26, 2024, the entire contents of which are incorporated herein by reference.

The present disclosure relates to a billet rotating and holding device, and a billet holding unit.

### BACKGROUND

Conventionally, devices for holding and rotating a billet (columnar workpiece) include devices that hold the outer circumferential surface of the billet with a plurality of jaws (chucks) arranged on the outer periphery of the billet (for example, Patent Literature (PTL) 1).

### CITATION LIST

### Patent Literature

PTL 1: JP S57-96731 U

### SUMMARY

### Technical Problem

However, when using the conventional device described above, it is necessary to secure space on the outer periphery of the billet for the plurality of claws that hold the billet, and in cases where it is difficult to secure space on the outer periphery of the billet, such a device may not be suitable.

Another method of holding and rotating the billet is to hold both ends of the billet. However, since the shape of the billet does not generally require high precision, the end face (cut face) of the billet is generally not perfectly perpendicular to the central axis of the billet, but is inclined in a non-perpendicular manner with respect to the central axis of the billet. In such cases, it is difficult to rotate the billet while firmly holding both ends.

The present disclosure has been conceived to solve the above-described problems, and it is an aim thereof to provide a billet rotating and holding device and a billet holding unit that can firmly hold both ends of a billet and rotate the billet even if the end faces of the billet are inclined.

### Solution to Problem

[1] A billet rotating and holding device configured to rotate a billet while holding the billet, comprising:
an electric motor comprising an electric motor shaft;
a pressurizer comprising a pressurizer shaft arranged to face the electric motor shaft in an axial direction; and
a billet holding unit, wherein
the billet holding unit comprises
   an electric motor-side holder attached to the electric motor shaft and configured to hold an end face of the billet on an axial direction first side, and
   a pressurizer-side holder attached to the pressurizer shaft and configured to hold an end face of the billet on an axial direction second side,
the pressurizer is configured to output a pressing force towards the axial direction first side via the pressurizer shaft,
the billet holding unit is configured to clamp the end faces of the billet on both axial direction sides with the electric motor-side holder and the pressurizer-side holder using the pressing force towards the axial direction first side outputted from the pressurizer shaft, and
the electric motor-side holder and the pressurizer-side holder each comprise
   a fixing portion configured to be fixed to the electric motor shaft or the pressurizer shaft and comprising an internal space open at least on an axial direction billet side,
   a floating portion configured to be movable in the axial direction within the internal space of the fixing portion, configured to be capable of transmitting a rotational torque between the fixing portion and the floating portion, and comprising a holding surface on the axial direction billet side configured to hold the end face of the billet on the axial direction first side or the axial direction second side, and
   a main body elastic portion formed by one or more disc springs and arranged substantially coaxially with the fixing portion between the fixing portion and the floating portion in the internal space of the fixing portion.
[2] The billet rotating and holding device according to [1], wherein
in each of the electric motor-side holder and the pressurizer-side holder,
   an outer circumferential surface of the floating portion comprises a plurality of engaging portions that are each configured to be convex or concave in a radial direction and that are arrayed along a circumferential direction,
   an inner circumferential surface defining the internal space of the fixing portion comprises a plurality of engaged portions that are each configured to be convex or concave in the radial direction, that are arrayed along the circumferential direction, and that engage with the plurality of engaging portions, and
   engagement between the plurality of engaging portions and the plurality of engaged portions enables transmission of rotational torque between the fixing portion and the floating portion.
[3] The billet rotating and holding device according to [1] or [2], wherein the holding surface of the electric motor-side holder comprises recesses and ridges that extend substantially in a radial direction and are alternately arrayed along a circumferential direction.
[4] The billet rotating and holding device according to [3], wherein a protruding tip edge of each of the ridges on the axial direction billet side extends in an axial direction billet-opposite side towards a radial inner side.
[5] The billet rotating and holding device according to [3] or [4], wherein the electric motor-side holder comprises an extrusion portion configured to protrude farther towards the axial direction second side than the holding surface and extrude the billet towards the axial direction second side when a force applied from the billet to the holding surface towards the axial direction first side becomes equal to or less than a predetermined value.
[6] The billet rotating and holding device according to any one of [1] to [5], further comprising
a magnetic field generation device configured to generate a magnetic field in a predetermined workspace, wherein
the billet rotating and holding device is configured to rotate the billet while holding the billet so that the billet is positioned within the predetermined workspace, generate a magnetic field in the predetermined workspace using the magnetic field generation device, and heat the billet by an induced current flowing within the billet during generation of the magnetic field.
[7] A billet holding unit configured to be used in the billet rotating and holding device according to any one of [1] to [6].

### Advantageous Effect

According to the present disclosure, it is possible to provide a billet rotating and holding device and a billet holding unit that can rotate a billet while firmly holding both ends of the billet, even if the end faces of the billet are inclined.

### BRIEF DESCRIPTION OF THE DRAWINGS

In the accompanying drawings:

FIG. 1 is a perspective view schematically illustrating a billet rotating and holding device, according to an embodiment of the present disclosure, that includes a billet holding unit according to an embodiment of the present disclosure;

FIG. 2 is a perspective view illustrating the electric motor-side holder of FIG. 1;

FIG. 3 is an axial cross-sectional view schematically illustrating the electric motor-side holder of FIG. 2 when no force is applied from the billet to the holding surface (natural state), the cross-section being taken along the central axis of the electric motor-side holder;

FIG. 4 is an explanatory diagram for explaining the operation of the electric motor-side holder in FIG. 2 when a force is applied to the holding surface from the billet;

FIG. 5 is an axial perpendicular direction cross-sectional view schematically illustrating the electric motor-side holder of FIG. 3, the cross-section being taken along line A-A of FIG. 3;

FIG. 6 is a perspective view schematically illustrating the pressurizer-side holder of FIG. 1;

FIG. 7 is an axial cross-sectional view schematically illustrating the pressurizer-side holder of FIG. 6 when no force is applied from the billet to the holding surface (natural state), the cross-section being taken along the central axis of the pressurizer-side holder;

FIG. 8 is an axial perpendicular direction cross-sectional view schematically illustrating the pressurizer-side holder of FIG. 7, the cross-section being taken along line B-B of FIG. 7;

FIGS. 9A to 9F are explanatory diagrams for explaining the function and effect of the billet rotating and holding device and the billet holding unit according to the embodiment of FIGS. 1 to 8; and

FIG. 10 is an explanatory diagram for explaining a billet rotating and holding device and a billet holding unit according to a variation of the present disclosure.

### DETAILED DESCRIPTION

The billet rotating and holding device and billet holding unit according to the present disclosure can be used for any purpose, for example, as a billet heating device for heating a billet (such as an aluminum billet).

Hereinafter, embodiments of a billet rotating and holding device and a billet holding unit according to the present disclosure will be described with reference to the drawings.

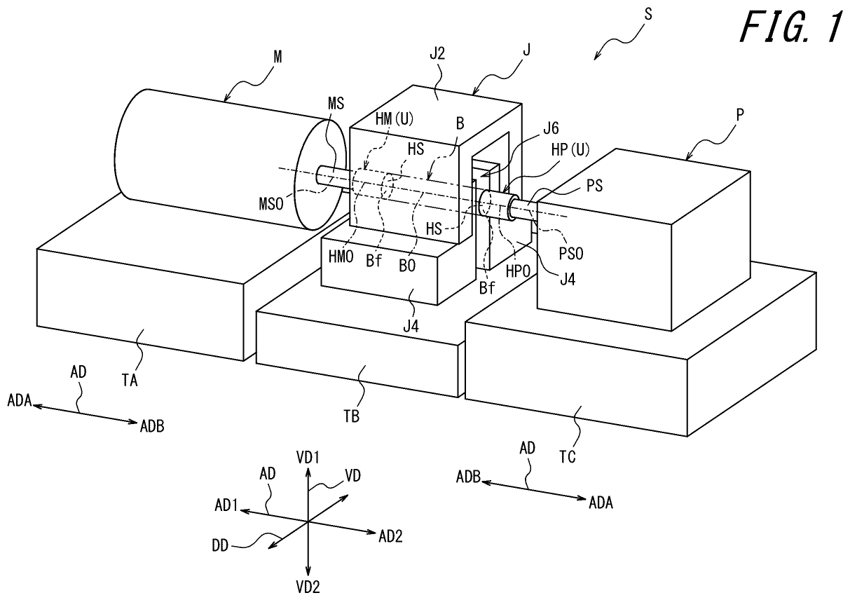

FIG. 1 is a schematic diagram of a billet rotating and holding device S according to an embodiment of the present disclosure. The billet rotating and holding device S is configured to rotate a billet (columnar workpiece) B while holding the billet B. FIG. 1 illustrates the billet rotating and holding device S holding the billet B.

The billet B is preferably made of metal, such as aluminum. Although the billet B has a substantially cylindrical shape in the example of FIG. 1, the billet B may have another columnar shape.

In the embodiment of FIG. 1, the billet rotating and holding device S includes an electric motor M, a pressurizer P, and a billet holding unit U according to an embodiment of the present disclosure. The billet holding unit U includes an electric motor-side holder HM and a pressurizer-side holder HP (in the present example, the billet holding unit U includes an electric motor-side holder HM and a pressurizer-side holder HP).

The billet holding unit U according to the present embodiment is configured so as to be usable in the billet rotating and holding device S according to any embodiment of the present disclosure.

As described below, the billet rotating and holding device S is configured to rotate the billet B while clamping the end faces Bf on both sides of the billet B via the billet holding unit U between an electric motor shaft MS of the electric motor M and a pressurizer shaft PS of the pressurizer P.

The electric motor M includes the electric motor shaft MS. The electric motor shaft MS is a drive shaft (output shaft) that outputs rotational torque.

The electric motor M may have any configuration, for example any known electric motor configuration.

As illustrated with an arrow in FIG. 1 and the like, for ease of explanation, the direction parallel to the central axis MSO of the electric motor shaft MS when the billet rotating and holding device S is holding a billet B (FIG. 1) is referred to as the “axial direction AD” in the present specification. One side in the axial direction AD is referred to as the “axial direction first side AD1”, and the other side in the axial direction AD is referred to as the “axial direction second side AD2”. The side closer to the billet B in the axial direction AD is referred to as the “axial direction billet side ADB”, and the side farther from the billet B in the axial direction AD is referred to as the “axial direction billet-opposite side ADA”. A direction perpendicular to the axial direction AD is referred to as an “axial perpendicular direction”. In the present specification, the circumferential direction centered on the central axis MSO (or an extension thereof) of the electric motor shaft MS may be simply referred to as the “circumferential direction”. Unless otherwise specified, the terms “outer circumferential side” and “inner circumferential side” refer to the outer circumferential side and the inner circumferential side, respectively, taking the central axis MSO (or an extension thereof) of the electric motor shaft MS as the center.

In the present specification, a direction perpendicular to the axial direction AD is referred to as a “vertical direction VD”, and the direction perpendicular to both the axial direction AD and the vertical direction VD is referred to as a “depth direction DD”. One side in the vertical direction VD is referred to as a “vertical direction first side VD1”, and the other side in the vertical direction VD is referred to as a “vertical direction second side VD2”. In the present embodiment, the vertical direction VD is oriented vertically, the vertical direction first side VD1 is oriented upward, and thus the axial direction AD and the depth direction DD are each parallel to the horizontal direction, but the vertical direction first side VD1 (and each of the other directions) may be oriented in any direction.

As illustrated in FIG. 1, the pressurizer P includes the pressurizer shaft PS. The pressurizer shaft PS is disposed so as to face the electric motor shaft MS in the axial direction AD. The tip of the electric motor shaft MS and the tip of the pressurizer shaft PS are spaced apart and opposed to each other in the axial direction AD. The electric motor shaft MS and the pressurizer shaft PS are preferably arranged so that their respective central axes MSO, HPO are positioned on substantially the same straight line. The electric motor M and the pressurizer P may be mounted on support stands TA and TC, respectively, and their respective heights and positions may be adjusted.

The pressurizer P is configured to output a pressing force towards the axial direction first side AD1 via the pressurizer shaft PS. The pressurizer shaft PS is configured to be displaceable in the axial direction AD and configured to output a pressing force towards the axial direction first side AD1 while being displaced towards the axial direction first side AD1.

The pressurizer shaft PS is configured as a driven shaft. In other words, when the billet rotating and holding device S is holding a billet B (FIG. 1), the pressurizer P is configured so that as a result of the rotational torque outputted from the electric motor shaft MS, the pressurizer shaft PS is rotated together with the billet holding unit U and the billet B while outputting the aforementioned pressing force.

The pressurizer P may have any specific configuration. The pressurizer P may be configured to displace the pressurizer shaft PS in the axial direction AD and output the pressing force by, for example, having an electric or hydraulic configuration. The pressurizer P may be automatically controlled by a processing device (CPU, circuit device, or the like) that performs various processes according to a predetermined program stored in any storage device (ROM, RAM, or the like), for example, or the pressurizer P may operate in response to human operation.

By the pressing force being outputted from the pressurizer shaft PS towards the axial direction first side AD1, the billet B is more firmly clamped between the electric motor shaft MS and the pressurizer shaft PS via the billet holding unit U, thereby preventing the billet B from falling out or becoming misaligned in the billet rotating and holding device S.

The billet holding unit U is formed by the electric motor-side holder HM and the pressurizer-side holder HP (FIG. 1).

The electric motor-side holder HM (also simply referred to as “holder HM”) is configured to be attached to the electric motor shaft MS. The electric motor-side holder HM is configured to hold the end face Bf of the billet B on the axial direction first side AD1 while attached to the electric motor shaft MS.

The pressurizer-side holder HP (also simply referred to as “holder HP”) is configured to be attached to the pressurizer shaft PS. The pressurizer-side holder HP is configured to hold the end face Bf of the billet B on the axial direction second side AD2 while attached to the pressurizer shaft PS.

When the electric motor-side holder HM is attached to the electric motor shaft MS and the pressurizer-side holder HP is attached to the pressurizer shaft PS, the electric motor-side holder HM and the pressurizer-side holder HP face each other in the axial direction AD (FIG. 1).

The billet holding unit U is configured to clamp the end faces Bf of the billet B on both sides in the axial direction AD with the electric motor-side holder HM and the pressurizer-side holder HP, using the pressing force towards the axial direction first side AD1 outputted from the pressurizer shaft PS.

In the embodiment in FIG. 1, the billet rotating and holding device S is configured as a billet heating device configured to heat the billet B. The billet rotating and holding device S further includes a magnetic field generation device J. The magnetic field generation device J is configured to generate a magnetic field in a predetermined workspace J6. In the present embodiment, the billet rotating and holding device S is configured to use the electric motor M, the pressurizer P, and the billet holding unit U to rotate (spin) the billet B while holding the billet B so that the billet B is positioned within the predetermined workspace J6, to use the magnetic field generation device J to generate a magnetic field in the predetermined workspace J6, and to heat the billet by an induced current flowing within the billet B during generation of the magnetic field. The billet B heated by the billet rotating and holding device S is then, for example, transported to a processing machine such as an extruder and subjected to processing such as extrusion.

The magnetic field generation device J may be placed on a support stand TB, and its height and position may be adjusted.

The magnetic field generation device J may have any configuration. The magnetic field generation device J may include, for example, an iron core J2, a superconducting coil (not illustrated), a vacuum insulated container J4, and the like. In this case, the superconducting coil (not illustrated) is housed inside the vacuum insulated container J4. As illustrated in FIG. 1, vacuum insulated containers J4 may be disposed on both sides of the predetermined workspace J6 (and thus the billet B) in the depth direction DD. Also, a portion of the iron core J2 may be housed inside the vacuum insulated container J4.

However, the billet rotating and holding device S may be used for purposes other than heating the billet B. The billet rotating and holding device S does not necessarily have to include the magnetic field generation device J.

The electric motor-side holder HM and the pressurizer-side holder HP will be described in more detail below.

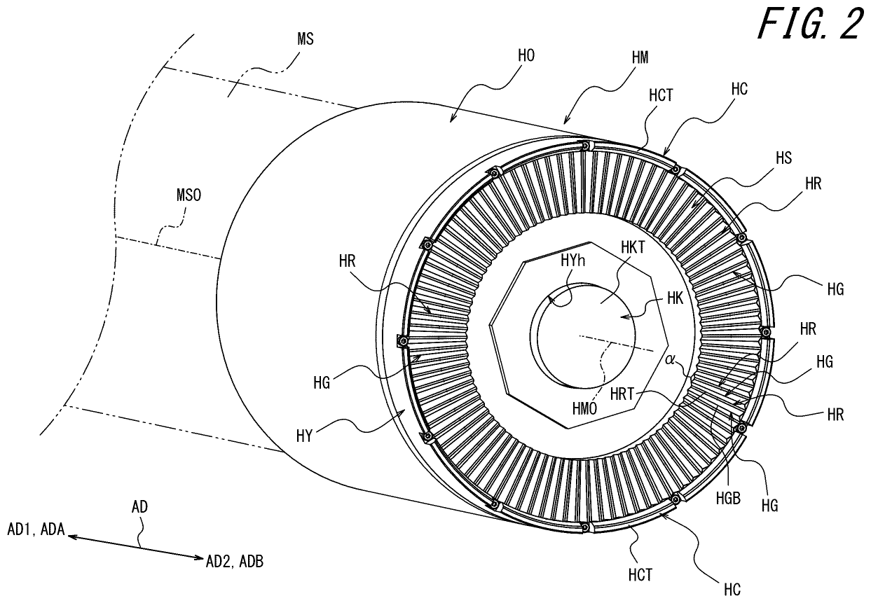

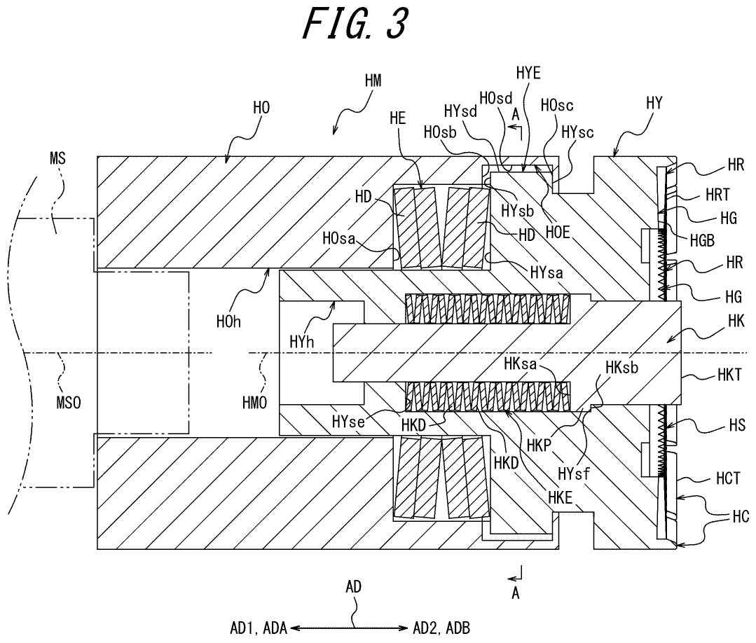

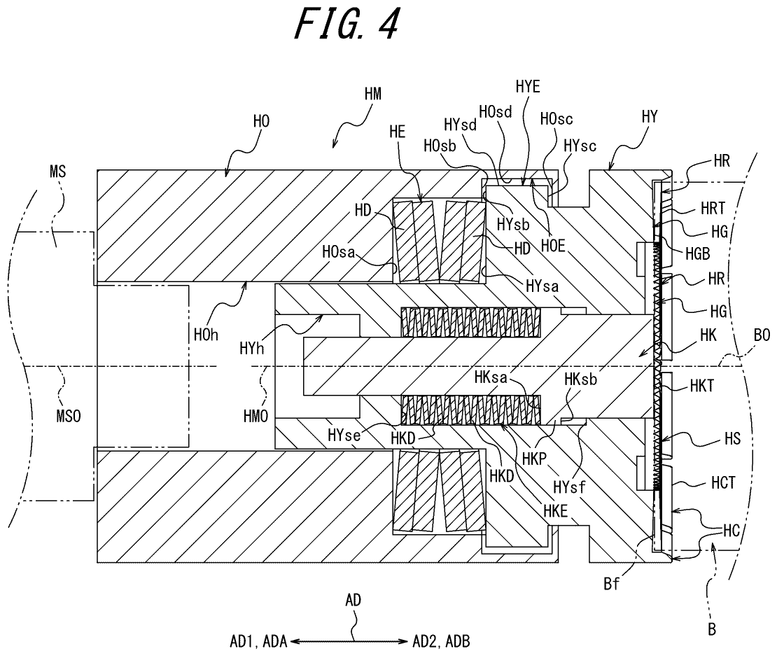

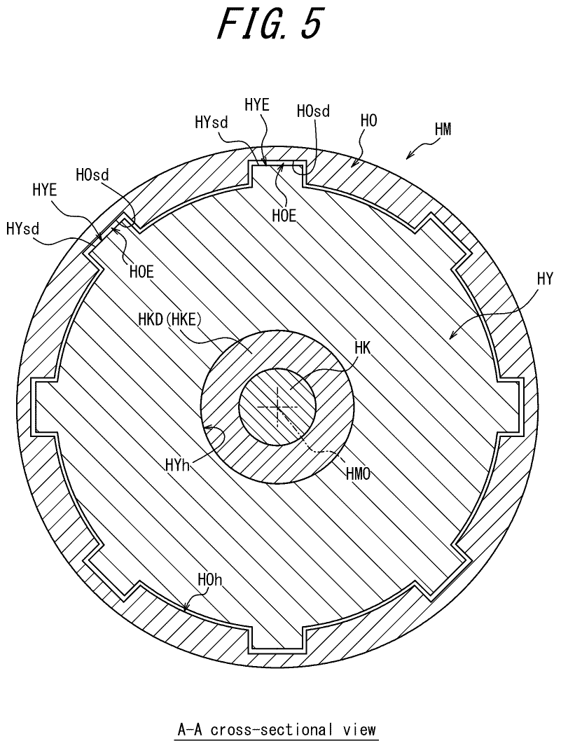

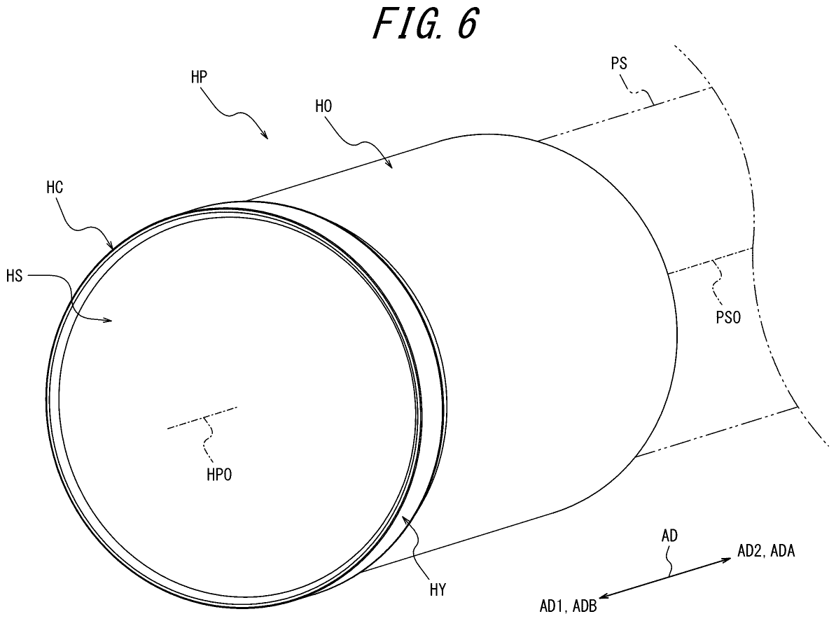

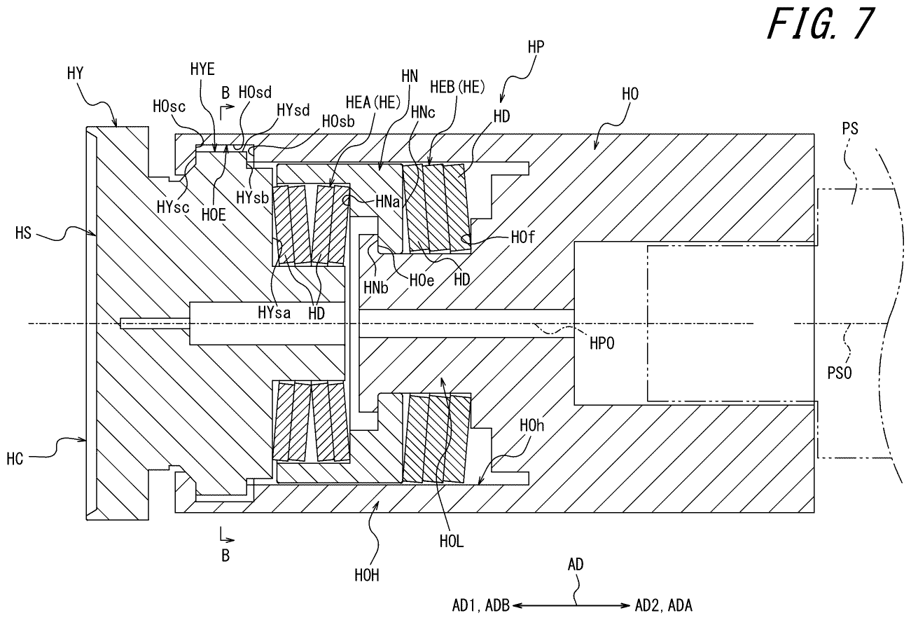

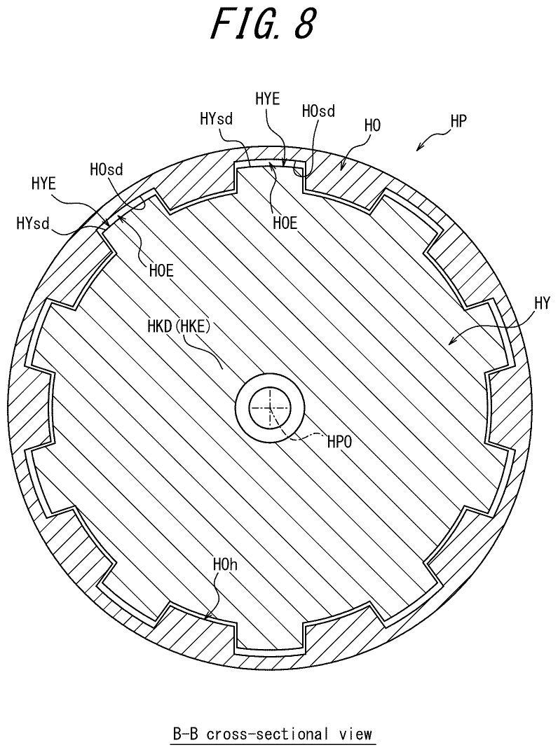

FIGS. 2 to 5 illustrate an example of the electric motor-side holder HM. FIG. 2 is a perspective view schematically illustrating an example of the electric motor-side holder HM. FIG. 3 is an axial cross-sectional view schematically illustrating the electric motor-side holder HM of FIG. 2 when no force is applied from the billet B to the holding surface HS of the electric motor-side holder HM (natural state), the cross-section being taken along the central axis HMO of the electric motor-side holder HM. FIG. 4 is an explanatory diagram for explaining the operation of the electric motor-side holder HM in FIG. 2 when a force is applied to the holding surface HS of the electric motor-side holder HM from the billet B. FIG. 5 is an axial perpendicular direction cross-sectional view schematically illustrating the electric motor-side holder HM of FIG. 3, the cross-section being taken along line A-A of FIG. 3, in parallel with the axial perpendicular direction. FIGS. 6 to 8 illustrate an example of the pressurizer-side holder HP. FIG. 6 is a perspective view schematically illustrating an example of the pressurizer-side holder HP. FIG. 7 is an axial cross-sectional view schematically illustrating the pressurizer-side holder HP of FIG. 6 when no force is applied from the billet B to the holding surface HS of the pressurizer-side holder HP (natural state), the cross-section being taken along the central axis HPO of the pressurizer-side holder HP. FIG. 8 is an axial perpendicular direction cross-sectional view schematically illustrating the pressurizer-side holder HP of FIG. 7, the cross-section being taken along line B-B of FIG. 7, in parallel with the axial perpendicular direction.

As illustrated in FIGS. 2 to 8, each of the holders HM, HP includes a fixing portion HO, a floating portion HY, and a main body elastic portion HE.

The fixing portion HO of the electric motor-side holder HM is configured to be fixed to the electric motor shaft MS (FIG. 3). As a result, the fixing portion HO of the electric motor-side holder HM is configured to integrate with the electric motor shaft MS and to move in conjunction with the electric motor shaft MS. The fixing portion HO of the electric motor-side holder HM is coaxial with the electric motor shaft MS when fixed to the electric motor shaft MS.

The fixing portion HO of the pressurizer-side holder HP is configured to be fixed to the pressurizer shaft PS (FIG. 7). As a result, the fixing portion HO of the pressurizer-side holder HP is configured to integrate with the pressurizer shaft PS and to move in conjunction with the pressurizer shaft PS. The fixing portion HO of the pressurizer-side holder HP is coaxial with the pressurizer shaft PS when fixed to the pressurizer shaft PS.

The fixing between the fixing portion HO and the electric motor shaft MS or the pressurizer shaft PS may be performed by any method and form, such as engagement, fastening, welding, or the like.

In each of the holders HM, HP, the fixing portion HO may be configured by connecting a plurality of separate members together by fastening or the like, or may be configured only from a single member. The fixing portion HO is preferably configured to include metal. The fixing portion HO may be made of a single material or may be made of a plurality of types of materials.

In each of the holders HM, HP, the fixing portion HO has an internal space HOh that is open at least on the axial direction billet side ADB (FIGS. 3 and 7). The internal space HOh of the fixing portion HO may be configured as a through hole penetrating the fixing portion HO in the axial direction AD by further opening the axial direction billet-opposite side ADA, or may be configured as a recess with only the axial direction billet side ADB open by closing the axial direction billet-opposite side ADA.

In each of the holders HM, HP, the floating portion HY is configured to be floatable (movable) in the axial direction AD within the internal space HOh of the fixing portion HO (FIGS. 3 and 7). The floating portion HY is arranged so as to be substantially coaxial with the fixing portion HO when no force is applied to the holding surface HS of the holders HM and HP from the billet B or the like (natural state) (FIG. 3).

More specifically, in the present embodiment, as illustrated in FIGS. 3 and 7, the outer circumferential surface of the floating portion HY includes a plurality of engaging portions HYE that are configured in a radially convex shape (i.e., have a shape that protrudes towards the outer circumferential side). The engaging portion HYE has a surface HYsc facing the axial direction billet side ADB, a surface HYsb facing the axial direction billet-opposite side ADA and located farther on the axial direction billet-opposite side ADA than the surface HYsc, and a surface HYsd facing the outer circumferential side and connecting the outer circumferential ends of the surface HYsc and the surface HYsb. The inner circumferential surface of the fixing portion HO that defines the internal space HOh includes a plurality of engaged portions HOE that are configured to be concave in the radial direction (i.e., have a shape recessed towards the outer circumferential side). The engaged portion HOE has a surface HOsc facing the axial direction billet-opposite side ADA, a surface HOsb facing the axial direction billet side ADB and located farther in the axial direction than the surface HOsc, and a surface HOsd facing the inner circumferential side and connecting the outer circumferential ends of the surface HOsc and the surface HOsb. The engaging portions HYE of the floating portion HY and the engaged portions HOE of the fixing portion HO are engaged with each other (FIGS. 3 and 7). The length in the axial direction AD of whichever of the engaging portion HYE and the engaged portion HOE is configured to be concave (in the present example, the engaged portion HOE) is longer than the length in the axial direction AD of whichever of the engaging portion HYE and the engaged portion HOE is configured to be convex (in the present example, the engaging portion HYE). That is, the distance in the axial direction AD between the surfaces HOsc, HOsb of the engaged portion HOE is longer than the distance in the axial direction AD between the surfaces HYsc, HYsb of the engaging portion HYE. Therefore, a gap exists in the axial direction AD between the engaging portion HYE and the engaged portion HOE, and thus, whichever of the engaging portion HYE and the engaged portion HOE is configured to be convex (in the present example, the engaging portion HYE) is enabled to move in the axial direction AD inside whichever of the engaging portion HYE and the engaged portion HOE is configured to be concave (in the present example, the engaged portion HOE). In the present example, the engaging portion HYE is movable in the axial direction AD between the surfaces HOsc and HOsb of the engaged portion HOE. That is, the floating portion HY is allowed to float in the axial direction AD relative to the fixing portion HO by an amount equal to the difference in length in the axial direction AD between the engaging portion HYE and the engaged portion HOE.

However, the configuration is not limited to this example, and for example, the engaging portion HYE of the floating portion HY may be configured to be concave in the radial direction (i.e., to have a shape recessed towards the inner circumferential side), and the engaged portion HOE of the fixing portion HO may be configured to be convex in the radial direction (i.e., to have a shape protruding towards the circumferential side).

In addition, when one engaging portion HYE or one engaged portion HOE is described in the present specification, it is assumed that each of the engaging portions HYE or each of the engaged portions HOE is being described unless otherwise specified.

In the present embodiment, in each of the holders HM, HP, the floating portion HY is configured to be able to transmit rotational torque between the floating portion HY and the fixing portion HO (FIGS. 5 and 8). As a result, the floating portion HY is movable relative to the fixing portion HO in the axial direction AD while being configured to rotate in conjunction with the fixing portion HO.

More specifically, in the present embodiment, as illustrated in FIGS. 5 and 8, the outer circumferential surface of the floating portion HY includes the above-described plurality of engaging portions HYE, and these engaging portions HYE are spaced apart from each other along the circumferential direction. The inner circumferential surface of the fixing portion HO that defines the internal space HOh includes the above-described plurality of engaged portions HOE, and these engaged portions HOE are spaced apart from each other along the circumferential direction and engage with the plurality of engaging portions HYE of the floating portion HY. In this manner, the engagement between the plurality of engaging portions HYE and the plurality of engaged portions HOE enables the transmission of rotational torque between the fixing portion HO and the floating portion HY.

Thus, in the present embodiment, the engagement relationship between the engaging portions HYE of the floating portion HY and the engaged portions HOE of the fixing portion HO enables the floating portion HY to float in the axial direction AD relative to the fixing portion HO, while also enabling transmission of rotational torque between the fixing portion HO and the floating portion HY.

In each of the holders HM, HP, the floating portion HY includes the holding surface HS, configured to hold the end face Bf of the billet B, on the axial direction billet side ADB of the floating portion HY (FIGS. 3 and 7). The holding surface HS is formed by at least a part of the end face of the axial direction billet side ADB of the floating portion HY. The holding surface HS of the electric motor-side holder HM is configured to hold the end face Bf of the billet B on the axial direction first side AD1 (FIG. 1). The holding surface HS of the pressurizer-side holder HP is configured to hold an end face Bf of the billet B on the axial direction second side AD2 (FIG. 1).

In each of the holders HM, HP, the floating portion HY may be configured by connecting a plurality of separate members together by fastening or the like, or may be configured only from a single member. The floating portion HY is preferably configured to include metal. The floating portion HY may be made of a single material or may be made of a plurality of types of materials. For example, the floating portion HY may be configured to include a thermal insulating material in addition to a metal or the like.

In the present embodiment, in each of the holders HM, HP, a portion of the floating portion HY extends towards the axial direction billet side ADB farther than the end face of the fixing portion HO on the axial direction billet side ADB, and thus the holding surface HS is located farther on the axial direction billet side ADB than the end face of the fixing portion HO on the axial direction billet side ADB (FIGS. 3 and 7).

In each of the holders HM, HP, the main body elastic portion HE is disposed between the fixing portion HO and the floating portion HY within the internal space HOh of the fixing portion HO (FIGS. 3 and 7). As a result, the main body elastic portion HE is configured to apply an elastic force between the fixing portion HO and the floating portion HY. The main body elastic portion HE is disposed substantially coaxially with the fixing portion HO (and thus substantially coaxially with the floating portion HY). The main body elastic portion HE is formed by one or more disc springs HD. The one or more disc springs HD configuring the main body elastic portion HE are arranged substantially coaxially with the fixing portion HO (and thus substantially coaxially with the floating portion HY).

The main body elastic portion HE preferably has a plurality of disc springs HD. In this case, the plurality of disc springs HD configuring the main body elastic portion HE are arrayed along the axial direction AD. The plurality of disc springs HD may be arrayed along the axial direction AD in any form, such as only in parallel, only in series, or in a combination of parallel and series.

In the present embodiment, the electric motor-side holder HM (FIG. 3) is configured so that the main body elastic portion HE is arranged within the internal space HOh in the fixing portion HO in the space between a surface HYsa, which faces the axial direction billet-opposite side ADA on the outer circumferential surface of the floating portion HY, and a surface HOsa, which faces the axial direction billet side ADB on the inner circumferential surface that defines the internal space HOh in the fixing portion HO and is farther on the axial direction billet-opposite side ADA than the surface HYsa. The main body elastic portion HE is in contact with these surfaces HYsa, HOsa when the holder HM is in its natural state (FIG. 3) and thus elastically connects these surfaces HYsa, HOsa to each other (and thus the floating portion HY and the fixing portion HO to each other).

In the holder HM, the main body elastic portion HE may be in a compressed state in the axial direction AD when the holder HM is in its natural state (FIG. 3), and thus the floating portion HY may be biased towards the axial direction billet side ADB by the main body elastic portion HE.

In the present embodiment, the pressurizer-side holder HP (FIG. 7) includes the main body elastic portion HE configured by two partial elastic portions HEA and HEB. Each of the partial elastic portions HEA and HEB is formed by one or more disc springs HD. An additional floating portion HN configured to floatable in the axial direction AD within the internal space HOh of the fixing portion HO is disposed between the two partial elastic portions HEA, HEB in the axial direction AD. The additional floating portion HN is located on the axial direction billet-opposite side ADA with respect to the floating portion HY (also referred to as the “main body floating portion HY”). The fixing portion HO includes, on the axial direction billet-opposite side ADA from the floating portion HY, a substantially cylindrical outer cylindrical portion HOH including the outer circumferential surface of the fixing portion HO, and an inner circumferential portion HOL located farther on the inner circumferential side than the outer cylindrical portion HOH. The internal space HOh is annular between the outer cylindrical portion HOH and the inner circumferential portion HOL. The outer cylindrical portion HOH extends towards the axial direction billet side ADB more than an end face of the inner circumferential portion HOL on the axial direction billet side ADB. One partial elastic portion HEA of the main body elastic portion HE is arranged inside a space, within the internal space HOh of the fixing portion HO farther on the axial direction billet side ADB than the inner circumferential portion HOL of the fixing portion HO, between a surface HYsa, which faces the axial direction billet-opposite side ADA on the outer circumferential surface of the floating portion HY, and a surface HNa, which faces the axial direction billet side ADB on the additional floating portion HN and is farther on the axial direction billet-opposite side ADA than the surface HYsa. The surface HYsa is located on the axial direction billet-opposite side ADA from the engaging portion HYE. The partial elastic portion HEA is in contact with these surfaces HYsa, HNa in the natural state of the holder HP (FIG. 7), and thus elastically connects these surfaces HYsa, HNa to each other (and thus the floating portion HY and the additional floating portion HN to each other). The other partial elastic portion HEB of the main body elastic portion HE is arranged inside a space, within the internal space HOh of the fixing portion HO on the outer circumferential side of the inner circumferential portion HOL of the fixing portion HO, between a surface HNc on the axial direction billet-opposite side ADA of the additional floating portion HN, and a surface HOf, which faces the axial direction billet side ADB on the outer circumferential surface of the inner circumferential portion HOL of the fixing portion HO and is farther on the axial direction billet-opposite side ADA than the surface HNc. The partial elastic portion HEB is in contact with these surfaces HNc, HOf in the natural state of the holder HP (FIG. 7), and thus elastically connects these surfaces HNc, HOf to each other (and thus the additional floating portion HN and the fixing portion HO to each other). The additional floating portion HN has a surface HNb facing the axial direction billet side ADB between the surfaces HNa and HNc in the axial direction AD. The surface HNb of the additional floating portion HN is restricted from displacement towards the axial direction billet side ADB by a surface HOe facing towards the axial direction billet-opposite side ADA on the outer circumferential surface of the inner circumferential portion HOL of the fixing portion HO. The surface HNb of the fixing portion HO is located farther on the axial direction billet side ADB than the surface HOf of the fixing portion HO. In this manner, in the present embodiment, the main body elastic portion HE of the pressurizer-side holder HP (FIG. 7) is configured to be able to apply an elastic force between the floating portion HY and the fixing portion HO via the additional floating portion HN, and thus elastically connects the floating portion HY and the fixing portion HO to each other.

In the holder HP, the main body elastic portion HE may be in a compressed state in the axial direction AD when the holder HP is in its natural state (FIG. 7), and thus the floating portion HY may be biased towards the axial direction billet side ADB by the main body elastic portion HE.

However, the holders HM, HP illustrated in FIG. 3 and FIG. 7 are merely examples, and the configuration of the holders HM, HP may be different from that of the present example. For example, both holders HM and HP may have the same configuration as the holder HM of the present example.

Here, an example of the operation of the billet rotating and holding device S (FIG. 1) according to the present embodiment with the above configuration will be described.

First, the electric motor shaft MS of the electric motor M and the pressurizer shaft PS of the pressurizer P are arranged in advance so that their respective central axes MSO, HPO are positioned substantially on the same straight line. At this time, the distance between the electric motor shaft MS and the pressurizer shaft PS is set to be longer than the length of the billet B. Subsequently, the billet B is transported to a position between the electric motor shaft MS and the pressurizer shaft PS. The billet B may be conveyed between the electric motor shaft MS and the pressurizer shaft PS by any appropriate device or by manual operation. In addition, the transport direction (movement direction) of the billet B when transporting the billet B to a position between the electric motor shaft MS and the pressurizer shaft PS may be any direction. For example, the billet B may be positioned between the electric motor shaft MS and the pressurizer shaft PS by moving the billet B in a direction towards the vertical direction first side VD1, in the depth direction DD, or in a direction towards the vertical direction second side VD2.

With the billet B positioned between the electric motor shaft MS and the pressurizer shaft PS, the pressurizer shaft PS is displaced towards the axial direction first side AD1, and the holding surfaces HS of the electric motor-side holder HM and the pressurizer-side holder HP of the billet holding unit U are each brought into contact with the corresponding end face Bf of the billet B. Thereafter, the pressurizer shaft PS is further displaced towards the axial direction first side AD1 while outputting a pressing force from the pressurizer shaft PS towards the axial direction first side AD1, thereby increasing the pressing force (clamping force) acting between the holding surfaces HS of the electric motor-side holder HM and the pressurizer-side holder HP, and ultimately compressing the billet B. When the pressing force (clamping force) becomes sufficiently large, the billet B is firmly held (clamped) by the holders HM, HP without falling out, and the electric motor shaft MS is then rotated by the electric motor M. The rotational torque outputted from the electric motor shaft MS is transmitted sequentially to the fixing portion HO of the electric motor-side holder HM, the floating portion HY of the electric motor-side holder HM, the billet B, the floating portion HY of the pressurizer-side holder HP, the fixing portion HO of the pressurizer-side holder HP, and the pressurizer shaft PS, causing these to rotate in conjunction with the electric motor shaft MS.

While the billet B is rotated, the magnetic field generation device J generates a magnetic field in a predetermined workspace J6 in which the billet B is located. During this time, the billet B is heated by an induced current flowing within the billet B.

The billet B heated by the billet rotating and holding device S is then, for example, transported to a processing machine such as an extruder and subjected to processing such as extrusion.

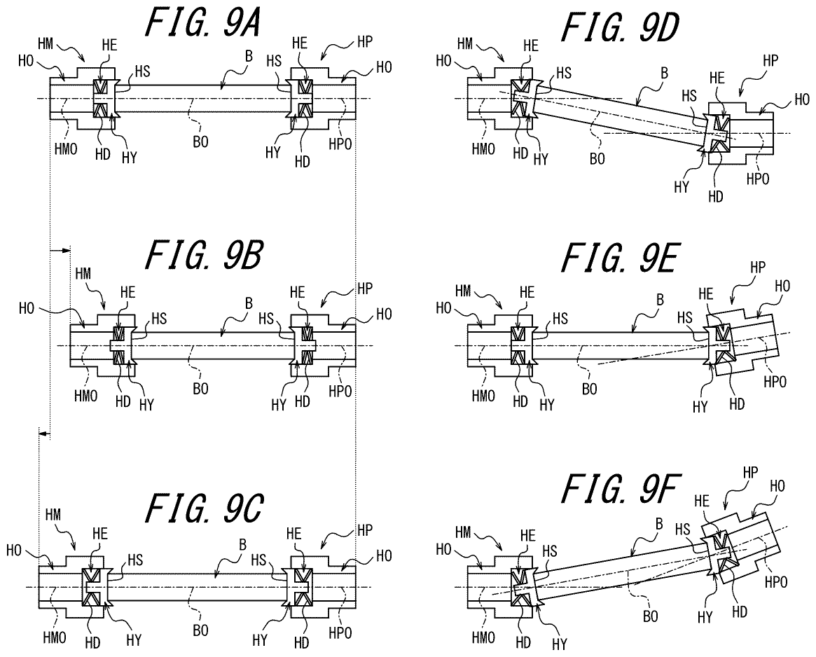

In the present embodiment, as described above, the floating portion HY is configured to be able to float in the axial direction AD within the internal space HOh of the fixing portion HO, and the main body elastic portion HE formed by one or more disc springs HD is arranged substantially coaxially with the fixing portion HO, between the fixing portion HO and the floating portion HY within the internal space HOh of the fixing portion HO. As a result, as illustrated in an exaggerated and schematic way in FIGS. 9D to 9F, the floating portion HY (and thus the holding surface HS) can tilt relative to the fixing portion HO so that the central axis of the floating portion HY is inclined relative to the central axis of the fixing portion HO while receiving an elastic force from the main body elastic portion HE. Therefore, if the end face Bf of the billet B is inclined non-perpendicularly with respect to the central axis BO of the billet B, the holders HM, HP firmly adhere to the end faces Bf of the billet B with the holding surfaces HS of the floating portions HY inclined with respect to the fixing portions HO, and can firmly hold both end faces Bf of the billet B by the pressing force from the pressurizer shaft PS and the elastic force from the main body elastic portion HE. In other words, the billet holding unit U is configured to be capable of absorbing errors in the inclination (shape errors) of both end faces Bf of the billet B. In this way, the billet rotating and holding device S can rotate the billet B while firmly holding both ends of the billet B, even if an end face Bf of the billet B is inclined, and can reduce the error between the mechanical center axis and the rotation axis of the billet B, thereby reducing unbalanced vibrations.

Furthermore, according to the above configuration of the present embodiment, even in the case of misalignment such that the central axis MSO of the electric motor shaft MS (and thus the central axis of the fixing portion HO of the electric motor-side holder HM) and the central axis PSO of the pressurizer shaft PS (and thus the central axis of the fixing portion HO of the pressurizer-side holder) are not perfectly aligned (for example, when both axes are parallel to each other but deviated in the vertical direction VD and/or the depth direction DD (FIG. 9D), or when both axes are not parallel to each other (FIG. 9E, FIG. 9F)), the misalignment can be absorbed by the floating portion HY being appropriately tilted with respect to the fixing portion HO. Therefore, the billet B can be rotated while both ends thereof are firmly held, and the error between the mechanical center axis and the rotation axis of the billet B can be reduced, thereby reducing unbalanced vibrations. As a result, the billet B can be prevented from falling out or being damaged. In the case in which the billet B is heated while being rotated as in the embodiment of FIG. 1, a decrease in the ability to heat the billet B can also be suppressed.

When the billet B is heated while being rotated as in the embodiment of FIG. 1, the length of the billet B may change during rotation. However, according to the above configuration of the present embodiment, the floating portion HY (and thus the holding surface HS) is made movable in the axial direction AD relative to the fixing portion HO while receiving an elastic force from the main body elastic portion HE. The billet B can therefore be rotated with both ends thereof firmly held, while such changes in the length of the billet B are followed stably (FIGS. 9A to 9C).

In each example described in the present specification, the holding surface HS of the electric motor-side holder HM preferably has a plurality of recesses HG and a plurality of ridges HR, as illustrated in FIG. 2. The recesses HG are recessed towards the axial direction billet-opposite side ADA. The ridges HR protrude towards the axial direction billet side ADB. These recesses HG and ridges HR each extend substantially in the radial direction, and are arranged alternately one by one along the circumferential direction.

As a result, as illustrated in FIG. 4, while the billet B is pressed against the holding surface HS by the pressing force from the pressurizer shaft PS, the end face Bf of the billet B can be caused to bite into the unevenness formed by the ridges HR and recesses HG on the holding surface HS. Consequently, unlike the case in which there is no unevenness on the holding surface HS, the torque from the electric motor shaft MS side can be transmitted not only by frictional engagement between the holding surface HS of the electric motor-side holder HM and the billet B, but also by mechanical engagement between the unevenness of the holding surface HS of the electric motor-side holder HM and the billet B, thereby improving the efficiency of torque transmission between the holding surface HS of the electric motor-side holder HM and the billet B.

As can be seen from FIG. 4, each of the ridges HR preferably has a substantially triangular or trapezoidal shape protruding towards the axial direction billet side ADB in a cross-section along the circumferential direction. In this case, the opening angle a (FIG. 4) of each ridge HR is preferably, for example, 55° to 65°, and more preferably 60°. This makes it possible to further increase the efficiency of torque transmission between the holding surface HS of the electric motor-side holder HM and the billet B.

Similarly, as can be seen from FIG. 4, each of the recesses HG preferably has a substantially triangular or trapezoidal shape recessed towards the axial direction billet-opposite side ADA in a cross-section along the circumferential direction.

On the holding surface HS of the electric motor-side holder HM, the protruding tip edge HRT of each ridge HR on the axial direction billet side ADB preferably extends towards the axial direction billet-opposite side ADA while moving radially inward, as illustrated in FIG. 3.

As a result, while the billet B is rotating, the end face Bf of the billet B is caused to bite further into the unevenness formed by the ridges HR and recesses HG on the holding surface HS from the outer circumferential side (and therefore the high torque side) of each ridge HR on the holding surface HS of the electric motor-side holder HM, and the central axis of the billet B is encouraged to approach (to be centered on) the central axis of the holding surface HS of the electric motor-side holder HM. This can further increase the torque transmission efficiency between the holding surface HS of the electric motor-side holder HM and the billet B and can reduce the error between the mechanical center axis and the rotation axis of the billet B, thereby reducing unbalanced vibrations. Consequently, the billet B can be prevented from being misaligned, falling off, being damaged, or the like. The outer circumference can also be made smaller than that of a conventional chuck.

On the holding surface HS of the electric motor-side holder HM, the bottom edge HGB of each recess HG on the axial direction billet-opposite side ADA may extend towards the axial direction billet side ADB while moving radially inward, as illustrated in FIG. 3.

However, the holding surface HS of the electric motor-side holder HM need not include the convex ridges HR and the concave ridges HG, like the holding surface HS of the pressurizer-side holder HP illustrated in FIG. 6, and may be nearly flat (substantially parallel to the axial direction) over nearly the entire holding surface HS.

The processing of the grooves in the peaks and valleys formed by the ridges HR and recesses HG is accomplished by forming straight, one-dimensional grooves using various blade processing tools with angled cutting edges on a surface processed into a mortar shape, and this can be done in combination with equal pitch control on a dividing table. This is highly productive and is thought to be cheaper than when two-dimensional or three-dimensional processing is used to form the grooves.

As illustrated in FIG. 6, the holding surface HS of the pressurizer-side holder HP need not be provided with the ridges HR and the recesses HG and may be nearly flat (substantially parallel to the axial direction) over nearly the entire holding surface HS.

As illustrated in FIGS. 2, 6, and the like, each of the holders HM, HP may include a guide projection HC that protrudes farther towards the axial direction billet side ADB than the holding surface HS on the outer circumferential side of the holding surface HS. The guide projection HC preferably extends along the circumferential direction. The guide projections HC may extend continuously around the entire circumference as in the example in FIG. 6 or may extend intermittently in the circumferential direction as in the example in FIG. 2. The presence of the guide projection HC makes it easier to position the billet B on the inner side of the guide projection HC when placing the billet B between the holders HM and HP, which in turn makes it easier to arrange the billet B so that the central axis BO of the billet B is positioned on approximately the same straight line as the central axes HMO and HPO of the holders HM and HP. In addition, the billet B can be prevented from falling off the holding surface HS or from becoming misaligned.

When the holding surface HS of the electric motor-side holder HM has ridges HR and recesses HG as described above, the electric motor-side holder HM preferably includes an extrusion portion HK (FIGS. 3 and 4). The extrusion portion HK is configured to protrude farther towards the axial direction second side AD2 (FIG. 3) than the holding surface HS (preferably, the protruding tip edge HRT of the ridge HR) and thereby extrude the billet B towards the axial direction second side AD2, thus causing the billet B to separate from the holding surface HS, when a force applied from the billet B to the holding surface HS towards the axial direction first side AD1 (specifically, the force applied from the pressurizer shaft PS via the pressurizer-side holder HP and the billet B to the holding surface HS of the electric motor-side holder HM) becomes equal to or less than a predetermined value.

In the electric motor-side holder HM in the example of FIGS. 3 and 4, the extrusion portion HK is disposed in an internal space HYh provided on the central axis HMO in the floating portion HY. The internal space HYh is open at least on the axial direction billet side ADB (on both sides in the axial direction AD in the illustrated example). The extrusion portion HK is configured to be movable in the axial direction AD within the internal space HYh. The extrusion portion HK includes a protrusion HKP that protrudes towards the outer circumferential side in the middle of its extension in the axial direction AD. The extrusion portion elastic portion HKE is provided in an internal space, within the internal space HYh of the floating portion HY, between a surface HKsa on the axial direction billet-opposite side ADA of the protrusion HKP of the extrusion portion HK, and a surface HYse, which faces the axial direction billet side ADB on the inner circumferential surface that defines the internal space HYh in the floating portion HY and is farther on the axial direction billet-opposite side ADA than the surface HKsa. The extrusion portion elastic portion HKE is formed by one or more disc springs HKD arranged approximately coaxially with the floating portion HY. The surface HKsb on the axial direction billet side ADB of the protrusion HKP of the extrusion portion HK faces the axial direction billet-opposite side ADA on the inner circumferential surface that defines the internal space HYh in the floating portion HY and is restricted from moving farther towards the axial direction billet side ADB by the surface HYsf positioned farther on the axial direction billet side ADB than the surface HYse.

While the force applied from the billet B to the holding surface HS towards the axial direction first side AD1 exceeds a predetermined value (FIG. 4), a tip surface HKT on the axial direction billet side ADB of the extrusion portion HK is pushed against the biasing force applied to the extrusion portion HK by the extrusion portion elastic portion HKE, towards the axial direction first side AD1 by the end face Bf of the billet B to approximately the same position as the holding surface HS in the axial direction AD. On the other hand, the extrusion portion HK is configured so that when the force applied from the billet B to the holding surface HS towards the axial direction first side AD1 becomes equal to or less than a predetermined value (such as the biasing force applied to the extrusion portion HK by the extrusion portion elastic portion HKE) (FIG. 3), the tip surface HKT on the axial direction billet side ADB of the extrusion portion HK protrudes farther towards the axial direction second side AD2 (FIG. 3) than the holding surface HS (preferably, the protruding tip edge HRT of the ridge HR) due to the biasing force by the extrusion portion elastic portion HKE, thereby extruding the billet B towards the axial direction second side AD2 and thus causing the billet B to separate from the holding surface HS.

By provision of the extrusion portion HK, the billet holding unit U first holds the billet B, and the end face Bf of the billet B then bites into the unevenness formed by the ridges HR and recesses HG provided on the holding surface HS of the electric motor-side holder HM (FIG. 4), after which the extrusion portion HK makes it easy to release the billet B from the unevenness formed by the ridges HR and recesses HG provided on the holding surface HS.

When the electric motor-side holder HM includes the guide projection HC as in the present example, the tip surface HKT on the axial direction billet side ADB of the extrusion portion HK is preferably capable of being displaced farther towards the axial second side AD2 than the protruding tip edge HCT on the axial direction second side AD2 of the guide projection HC (FIG. 3).

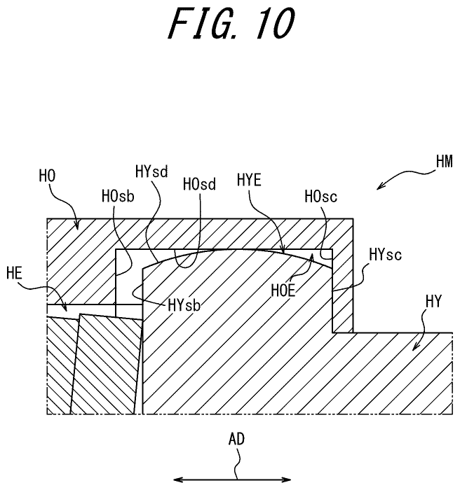

As in the modification illustrated in FIG. 10, each of the holders HM, HP may be configured so that the engaging portion HYE of the floating portion HY and the engaged portion HOE of the fixing portion HO form a gear coupling. That is, for example, the surface HYsd of the engaging portion HYE facing the outer circumferential side may be curved so as to be convex towards the outer circumferential side in an axial cross-section (FIG. 10). This makes it easier for the floating portion HY to tilt relative to the fixing portion HO.

### INDUSTRIAL APPLICABILITY

The billet rotating and holding device and billet holding unit according to the present disclosure can be used for any purpose, for example, as a billet heating device for heating a billet (such as an aluminum billet).

### REFERENCE SIGNS LIST

S Billet rotating and holding device
M Electric motor
MS Electric motor shaft
MSO Central axis of electric motor shaft
P Pressurizer
PS Pressurizer shaft
PSO Central axis of the pressurizer shaft
J Magnetic field generation device
J2 Iron core
J4 Vacuum insulated container
J6 Predetermined workspace
TA, TB, TC Support stand
U Billet holding unit
HM Electric motor-side holder (holder)
HMO Central axis of electric motor-side holder
HP Pressurizer-side holder (holder)
HPO Central axis of pressurizer-side holder
HO Fixing portion
HOh Internal space
HOsa, HOsb, HOsc, HOsd, HOf Surface
HOE Engaged portion
HOH Outer cylindrical portion
HOL Inner circumferential portion
HY Floating portion (main body floating portion)
HYsa, HYsb, HYsc, HYsd, HYse, HYsf Surface
HYE Engaging portion
HS Holding surface
HG Recess
HGB Bottom edge of recess
HR Ridge
HRT Protruding tip edge of ridge
HC Guide projection
HCT Protruding tip edge of guide projection
HYh Internal space
HE Main body elastic portion
HEA, HEB Partial elastic portion
HD Disc spring
HK Extrusion portion
HKT Tip surface
HKP Protrusion
HKsa, HKsb Step surface
HKE Extrusion portion elastic portion
HKD Disc spring
HN Additional floating portion
HNa, HNb, HNc Surface
B Billet
Bf End face in axial direction
BO Central axis of billet
AD Axial direction
AD1 Axial direction first side
AD2 Axial direction second side
ADB Axial direction billet side
ADA Axial direction billet-opposite side
VD Vertical direction
VD1 Vertical direction first side
VD2 Vertical direction second side
DD Depth direction

1. A billet rotating and holding device configured to rotate a billet while holding the billet, comprising:
an electric motor comprising an electric motor shaft;
a pressurizer comprising a pressurizer shaft arranged to face the electric motor shaft in an axial direction; and
a billet holding unit, wherein
the billet holding unit comprises
an electric motor-side holder attached to the electric motor shaft and configured to hold an end face of the billet on an axial direction first side, and
a pressurizer-side holder attached to the pressurizer shaft and configured to hold an end face of the billet on an axial direction second side,
the pressurizer is configured to output a pressing force towards the axial direction first side via the pressurizer shaft,
the billet holding unit is configured to clamp the end faces of the billet on both axial direction sides with the electric motor-side holder and the pressurizer-side holder using the pressing force towards the axial direction first side outputted from the pressurizer shaft, and
the electric motor-side holder and the pressurizer-side holder each comprise
a fixing portion configured to be fixed to the electric motor shaft or the pressurizer shaft and comprising an internal space open at least on an axial direction billet side,
a floating portion configured to be movable in the axial direction within the internal space of the fixing portion, configured to be capable of transmitting a rotational torque between the fixing portion and the floating portion, and comprising a holding surface on the axial direction billet side configured to hold the end face of the billet on the axial direction first side or the axial direction second side, and
a main body elastic portion formed by one or more disc springs and arranged substantially coaxially with the fixing portion between the fixing portion and the floating portion in the internal space of the fixing portion.

2. The billet rotating and holding device according to claim 1, wherein
in each of the electric motor-side holder and the pressurizer-side holder,
an outer circumferential surface of the floating portion comprises a plurality of engaging portions that are each configured to be convex or concave in a radial direction and that are arrayed along a circumferential direction,
an inner circumferential surface defining the internal space of the fixing portion comprises a plurality of engaged portions that are each configured to be convex or concave in the radial direction, that are arrayed along the circumferential direction, and that engage with the plurality of engaging portions, and
engagement between the plurality of engaging portions and the plurality of engaged portions enables transmission of rotational torque between the fixing portion and the floating portion.

3. The billet rotating and holding device according to claim 1, wherein the holding surface of the electric motor-side holder comprises recesses and ridges that extend substantially in a radial direction and are alternately arrayed along a circumferential direction.

4. The billet rotating and holding device according to claim 3, wherein a protruding tip edge of each of the ridges on the axial direction billet side extends towards an axial direction billet-opposite side while moving radially inward.

5. The billet rotating and holding device according to claim 3, wherein the electric motor-side holder comprises an extrusion portion configured to protrude farther towards the axial direction second side than the holding surface and extrude the billet towards the axial direction second side when a force applied from the billet to the holding surface towards the axial direction first side becomes equal to or less than a predetermined value.

6. The billet rotating and holding device according to claim 1, further comprising
a magnetic field generation device configured to generate a magnetic field in a predetermined workspace, wherein
the billet rotating and holding device is configured to rotate the billet while holding the billet so that the billet is positioned within the predetermined workspace, generate a magnetic field in the predetermined workspace using the magnetic field generation device, and heat the billet by an induced current flowing within the billet during generation of the magnetic field.

7. A billet holding unit configured to be used in the billet rotating and holding device according to claim 1.
